(19) United States
(12) Patent Application Publication
(10) Pub. No.: US 2008/0263048 A1
(43) Pub. Date: Oct. 23, 2008

(54) File Access Management System

(76) Inventor: Kelley Wise, Villa Park, CA (US)

Correspondence Address: FISH & ASSOCIATES, PC;ROBERT D. FISH, 2603 Main Street, Suite 1050, Irvine, CA, 92614-6232, US

(21) Appl. No.: 12/104,314

(22) Filed: Apr. 16, 2008

Related U.S. Application Data
(60) Provisional application No. 60/912,105, filed on Apr. 16, 2007.

(51) Int. Cl. H04L 9/32; G06F 17/30

(52) U.S. Cl. 707/9; 707/10; 707/E17.005; 707/E17.009

(57) ABSTRACT

The present invention provides systems and methods for a medical record and image and data managing system for storing electronic records and data from multiple sources including but not limited to medical databases and file capture or data storage and file management systems and then making the data and the files accessible securely over a network or wide area network from multiple similar systems that share the same user access and authorization level data, and patient records and data or over a wide area network like the Internet, and provide the records and the data to patients and physicians. The records and data are stored in electronic folders in a data base and file storage system which uses meta information entered by the patient or medical provider when the folder is made or edited which provides control over access to the electronic patient folder, identifying criteria for locating each folder and file with a search engine and an anonymous user identification number and data fields for the input of meta data showing the patient's medications used, diagnosis or existing conditions for data mining by a system which uses a blind data pool to extrapolate outcomes or other medical data from the data fields on the patient folder and on the identifying information attached to each patient file that is stored in the digital patient folders.

This application claims priority to U.S. provisional application having Ser. No. 60/912,105 filed on Apr. 16, 2007 which is incorporated by reference herein in its entirety.

### CROSS-REFERENCE TO RELATED APPLICATIONS

This invention relates to an improved method and system for managing access and distribution of medical files over prior invention: U.S. Pat. No. 6,678,703—Rothschild, et al, Jan. 13, 2004.

### BACKGROUND OF THE INVENTION

It is very desirable to provide medical records and data and medical reports to patients, physicians, and other authorized users over the Internet rather than waiting for a hard copy to be created and sent to the recipient to then view remotely. Radiologists using advanced imaging systems like CT and MRI for example need to provide a medical report with images digitally to the patients which can be time consuming to create and ship a physical copy for the physician and or their technologists. The files usually on a CR ROM are received by the patient and their physician one to two days later. DICOM and other types of image files as well as video and AVI and document files may be securely published online for the only the patient and their authorized physician to view over the Internet without the need for a virtual private network.

A present embodiment of this invention of a medical file management system relies on a push system to stream or download data into remote viewing computer workstations and uses a central management system to centrally manage the storage and transmission of electronic records containing medical images between remotely located facilities. This present embodiment is useful for physician's however this system is unacceptable for providing medical data to patients and unaffiliated referring physicians because it allows files to download and reside on the remote viewing computer and is unacceptably slow and inherently unable to insure patient privacy when initiated on a broad scale.

Embodiments according to the concepts discussed herein are inherently more secure than a push based system because the files are not actually downloaded onto the remote viewing computer or downloading is not required and the system functions as a separate operational layer from mission critical medical information systems such as PACS and RIS which are only meant to be accessed by physicians, technologists and authorized medical facility employees. In My invention, an electronic patient folder is created in the medical file manager system for each patient with identifying demographic metadata in data fields that provide search terms or keywords for the system's search engine to locate the patient's folder and files. Each electronic patient has an editable authorized user access list that allows the patient and authorized users in the system named in this list to search for that patient's folder and each of the files pertaining to that patient in the system and view the desired files remotely. Each data source on the system keeps the same patient and authorized user data to gain access to any files for any given patient in the system. The patient and user data and user access authorization is managed by a central system management server or servers to allow for multiple devices on this system to operate as a medical ASP that forms a secure medical Internet.

### BRIEF SUMMARY OF THE INVENTION

The present invention provides systems and methods in which a database or other data store includes a data element; a server or other a facility that streams the data element to a user; and wherein the user has at least partial control over streaming of the data element to another person. The user in this context is a typical patient or other ordinary human user, not a programmer or systems person who would have control over streaming of the data element to another person by virtue of his special knowledge, skill, or position.

As currently contemplated, the data element would typically contain at least one of an image, video or other moving image, audio information, and as such would typically comprise or all part of a media file. It is especially contemplated that the data element could include medical information, including, for example, all or part of an x-ray or MRI image, or other medical image. It is especially contemplated that at least one of the data elements could comprise a DICOM file.

In preferred embodiments, the facility streams the data element to the user upon demand by the user, but such access is at least partially controlled by an authorization subsystem. Among other thing the authorization process can advantageously allow the user to designate different levels of upload, download or other access, and can designate access to a physician, a friend, a relative, or one or more other specific or groups of individuals. It is contemplated that a user could even modify physician access to the data element.

The data store is preferably distributed among a plurality of geographically distributed data servers, perhaps each of which is operated by a different entity. In a medical environment individual data stores could, for example, be operated by doctor's offices, medical imaging centers, hospitals, and so forth. In an entertainment environment, individual data stores could be operated by individual persons having media content, copyright holders (e.g., Sony, music companies, and so forth), or licensees.

In any event it is contemplated that each of the data servers could pull portions of the data store from a plurality of sources, including the other data serves. For medical data, the information could advantageously be pulled through pulls through an HL7 interface.

In a currently preferred embodiment, authorization codes are stored on an authorization server, which is independent of any of the data servers, so that none of the data servers has all of the authorization codes.

To facilitate searching and location of folders, files, records, or other portions of the data store, the system can advantageously use metadata to tag such portions, and such tagging can be performed independently of the user. All suitable tags are contemplated, and the specific tags used would very likely depend upon the type of information being tagged. In a medical environment, for example, the metadata tagging would likely include demographic information of the user, and very possibly at least one of physician identification, diagnosis, treatment, and medical outcome information. In an entertainment environment, the tags might be the names of the authors, performers, titles of works, and so forth.

Streaming is the preferred way to transmit data, partly because one can then realistically send data to PDA's or other devices with relatively small memories, and partly because one can stream data elements to a virtual machine within a target device, which could preclude the recipient from being able to store and/or retransmit the data being received. In the current programming environment, the facility therefore preferably streams the data elements to an applet, which is then used to display and/or manipulate the received data.

In an especially preferred embodiment, one or more servers with medical records and patient data stored on them, or non medical data for non medical applications, run application provider service software to make medical records, data and files locatable with a secure search engine that limits the results according to authorization and allows for secure remote viewing of the files over a wide area network like the Internet. The system uses electronic patient folders with demographic metadata for the search engine and an editable list of users authorized to access the file in the electronic folder which is identifiable by all data source servers on the system through the authorization provided over all the servers on the system by a central system management server. The Invention uses a secure log in system and streams the data to the remote viewer using the “Virtual Remote Medical Diagnostic Viewer” to prevent unauthorized access to the files. Besides the objectives and advantages of the preferred embodiment of the invention described above, there are other objectives and advantages also which are: o lower the cost of healthcare by distributing medical files over the Internet instead of providing hard copies for everything; to provide faster access to files; to provide a secure method to search for files without knowing the file's location and to provide mechanisms for improve patient and physician interaction and improved communication.

### BRIEF DESCRIPTION OF THE DRAWINGS

FIG. 1 shows a representation of the medical data management and access system for storing data at one or more locations and providing the data remotely according to a user authorization hierarchy.

FIG. 2 shows a representation of the method for creating electronic patient folders with identifying metadata for use with a search engine and creation of user accounts for system and data access.

FIG. 3 shows a representation of the method of accessing the system, searching for authorized data and remotely viewing and manipulating the data without the data being downloaded.

FIG. 4 shows a representation of the access view of patient folders and their identifying demographic metadata as seen by a system user inside Medical File Manager of a designated server, referred to herein as the BioNetMedia™ Server.

FIG. 5 shows a representation of the access view of patient files waiting to be selected and viewed and their identifying demographic metadata as seen by a user inside Medical File Manager of a BioNetMedia Server.

### DETAILED DESCRIPTION

The present invention describes the apparatus for a medical data managing system for storing, and providing access to digital medical records and medical data or other non medical data such as copyrighted multi-media, securely over a network or wide area network. The system functions as a multi site “application service provider” (ASP) that is centrally accessible from remote locations and will share access to data with users of other embodiments of the invention. The following are specific embodiments which are among the benefits associated with the invention the (“system”):

Electronically deliver medical data or non medical data in different forms including electronic record form to remote users and to physicians and patients and other authorized users outside of the facility where each operational embodiment of system is located via a streaming technology which does not allow the file to be downloaded.

The present invention (the system) will revolutionize the delivery of medical data to patient's and physicians by making the data available to them remotely and from any personal computer or device with internet access and eliminating the need for hard copies of the data or records and files. It also allows simultaneous access to the same data or files or records by different authorized users.

Presently in current methods as described in prior art U.S. Pat. No. 6,678,703, when a patient is admitted to a hospital a folder is created which provides the hospital personnel the patient's demographic information, medical history, and other relevant data. In a typical medical diagnostic imaging department of a hospital or free standing imaging facility, medical folders are created for each patient when a diagnostic study is ordered by the patient's physician at the time the patient registers for the procedure at the facility or online in some cases in a digital version or a hard copy version of a patient folder with each patient's identifying demographic information and medical history and other required information becomes associated with each patient's folder and medical records and data files contained in the folder. A folder can reside digitally in a patient records system or a picture archiving communications system (PACS) or radiological information system (RIS) or any type of system that stores data on patients and their files and or other medical data. The technologist would add diagnostic data and other data for each patient to the patient's folder either as a digital file to a digital patient folder in one or more of the aforementioned systems or a hard copy to a hard copy folder stored on a shelf usually.

Medical data and diagnostic imaging data is gathered by diagnostic systems such as CT, MRI, PET, SPECT, Ultrasound, digital x-ray, digital and other digital data acquisition systems and then the data is stored with a patient data base and file storage of the corresponding files in systems with storage devices such as PACS systems and RIS systems and other systems for this purpose, and then make the data available for viewing though a computer diagnostic workstation accessing the system through a network or other computer system intended to access and view this data.

These medical data management systems represent the presently used methods to gather data as medical studies and store the studies in each patient's folder. Using present versions of a medical ASP or PACS or RIS that allows remote viewing or provides a web viewer, the patient folder is accessible only to authorized personnel at the facility and remote users such as radiologists and authorized physicians but not to patients that wish to access their records and data and files remotely. Presently a radiologist or other physician or a technologist must save a copy of diagnostic studies and medical reports such as a radiology report to persistent memory device and provide copies of the file or medical reports with or without images as hard copy print outs and/or film or burn the reports and data and patient files to a CD ROM or DVD and deliver the disk or documents and images to the patient or their physician. Patient records and medical and diagnostic data may be retained by the provider for seven years, one solution is to store digital files on an archiving server or database and file and data storage device for this purpose. Files and data can then be made available to authorized personnel for remote access but this data is generally not available to patient or physicians through public access methods at every location or with every system.

Currently medical data is very difficult to locate over the Internet in any kind of search function. There is an existing system for using a medical reporting router and a patient index system where patients, providers, hospitals, diagnostic services, payors, and public health providers would send a request for medical data to a national patient file index which holds the locations of the medical files requested. This file index sends the location information back to the patient, provider, or payor that was requesting the information. The patient, provider, or payor, then request those desired files from the source of the data which could be patients, providers, hospitals, diagnostic service, payors, or public health providers, which would then send the requested digital or hard copy data and medical records. In this model the data source, would also be able to push data to a reporting router which would then be able to push data over the Internet to authorized physicians and patients. The reporting router would provide de-identified data to public health agencies by push data over the Internet for downloading de-identified data.

In my novel invention, in one of the preferred embodiments of the invention for a medical data and medical file management system which I call “BioNetMedia” which shall herein be called the (“System”) which contain a method and system for managing the records and files of patients and medical data and or secure data of any type shall be herein referred to as (“Medical File Manager”), the patient's data is saved manually or automatically to an archiving server and or persistent memory device, hard drive, or mass storage device and then is stored in a digital patient folder which has identifying meta data for the patient to locate the data and view the data remotely and to allow authorized users or the patient to provide access to physicians or other authorized users to view the data remotely.

The preferred embodiment of this invention will speed delivery of the medical data to the patient and the physician by making the data and reports and files available online in a secure browser based system, without the files having to be downloaded into whichever computer the patient or physician is using. This system gives the patient access on demand to all their data stored on the system or in other storage devices which the system may access.

An alternative embodiment of this invention would utilize an ASP model to have the date first pushed from a data source to a central data storage system that would the stream the data to the remote users from that location along with or instead of the

The U.S. government has called for all medical data to be digital by 2014, and this system is an efficient and secure method to deliver medical data securely to patients and all authorized parties in the most secure and cost effective manner possible.

In contrast to existing push systems that push the data to the remote viewer, this system relies on streaming the medical data to the remote viewer using the Virtual Remote Medical Diagnostic Viewer.

“Remote Medical Data Viewing System”

In order for the patient and the physician to view the medical records or any medical data on this system, a remote viewing system is used that incorporates U.S. Pat. No. 7,181,617 which describes Medical Application Provider Servers which is this system described herein whereas the medical application provider servers are the duplicate system in claim 1 that share the user data and share access to the patient files that each server contains patient files which are managed by our innovative medical file manager system which is described herein and allow the remote user to view and manipulate the data using the “Remote Virtual Medical Diagnostic Imaging Viewer” or the patent pending “Remote Data Viewer”. When the file is selected and the user chooses to open the file inside the medical file manager system to view the data, the system launches the remote virtual medical diagnostic imaging viewer which then streams the medical data file code over the Internet to the secure execution environment created by the remote virtual medical diagnostic imaging viewer which is put through a matrix manipulation to allow the user to manipulate the data and view the data without the data being downloaded and independently of the operating system of the remote users computer.

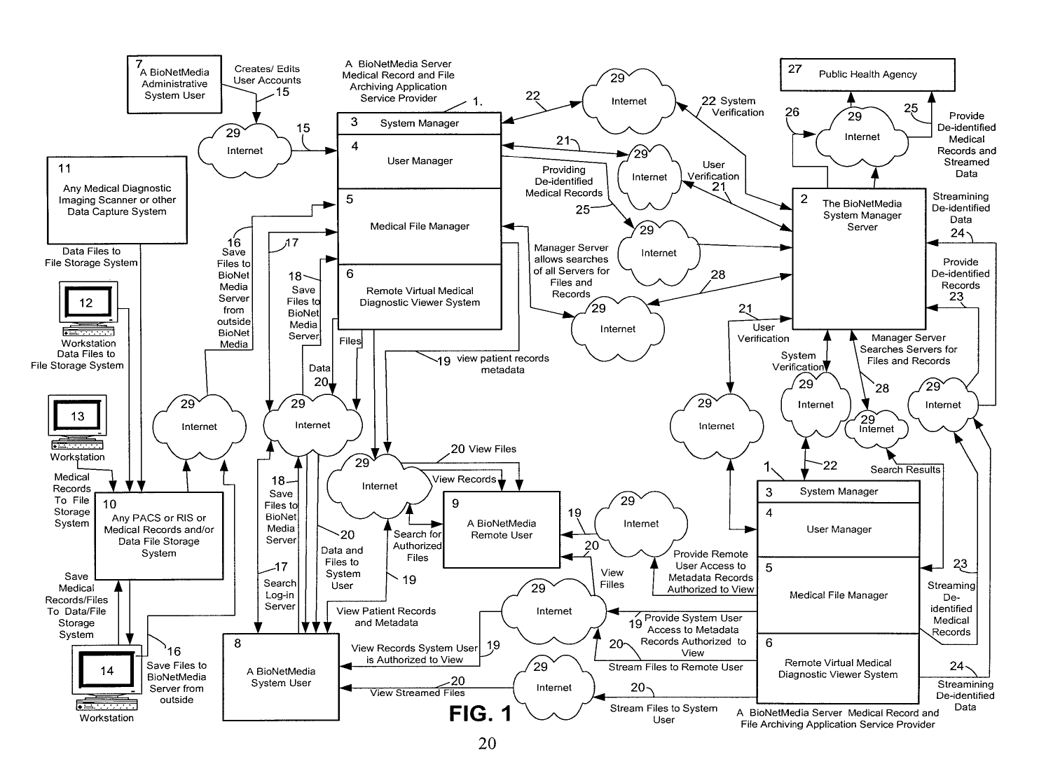

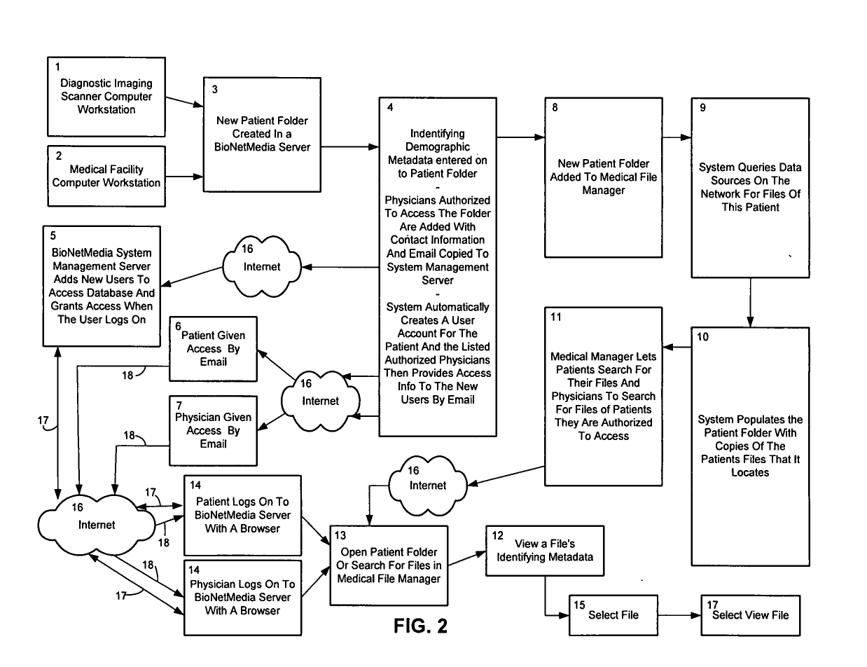

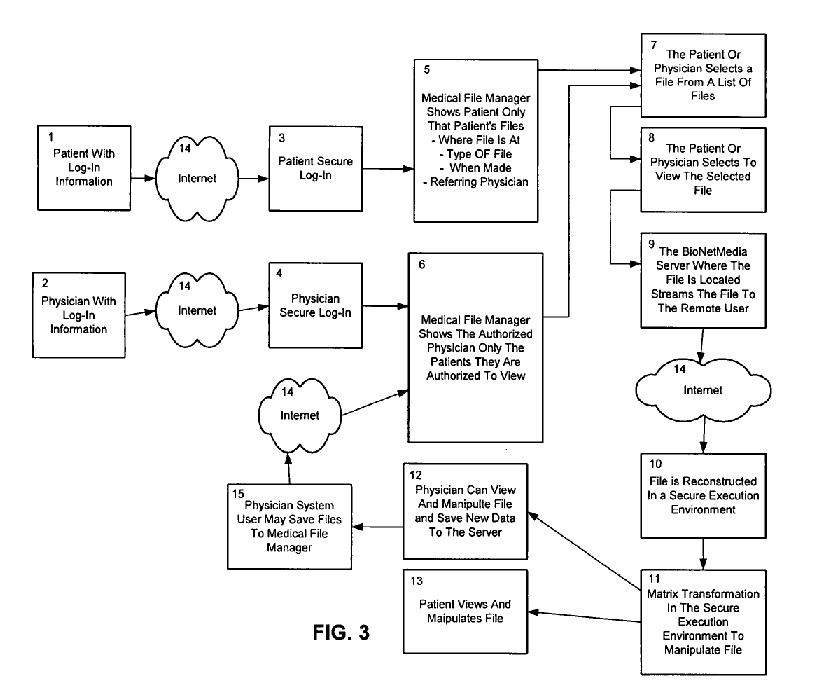

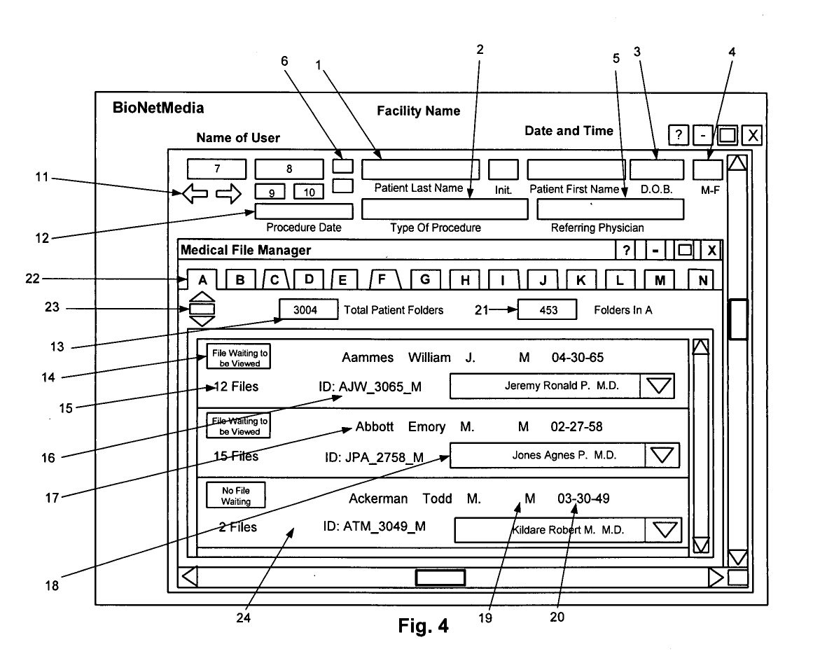

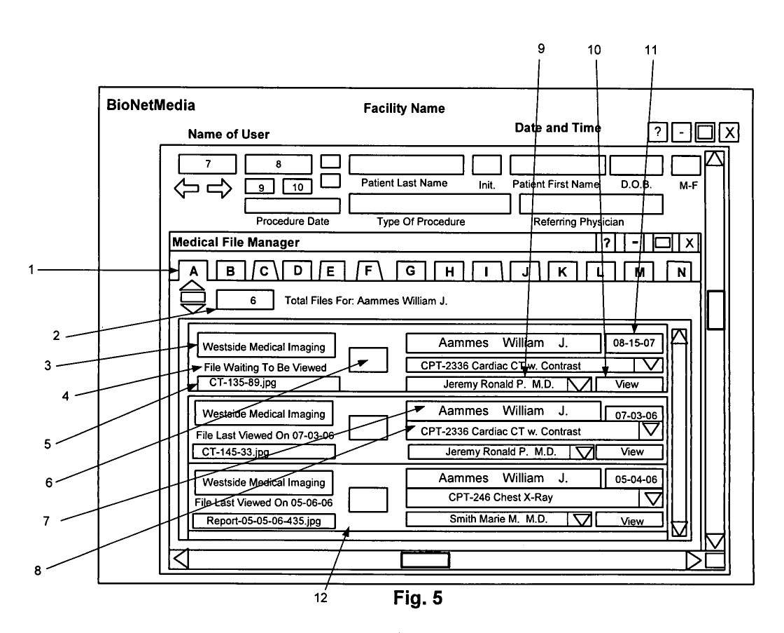

A preferred embodiment of the invention for medical applications is described in the following illustrations FIG. 1, FIG. 2, FIG. 3, FIG. 4, and FIG. 5. The system is implemented as software operating as a multifunction ASP installed on one or more computer servers and one or more computer servers that function as a system management server that allows authorized users to search for files in all the servers.

In FIG. 1 the invention is illustrated as a flow chart to illustrate the medical data management and access system for storing data at one or more locations and providing the data to remote user according to a user authorization hierarchy. The Primary component of the system is the BioNetMedia Server (1) which is installed on the network in a hospital, medical imaging facility, or other data generating medical facility that wants to provide access to these files to the patients and their physicians that are authorized to view the files securely over the Internet. The other key component of the system is the BioNetMedia system management Server (2) which serves as the administrator of all the BioNetMedia Servers (1). The System Management Server (2) activates each BioNetMedia Server (1) that is brought online on the Internet with a verification system (22) that performs a handshake with each BioNetMedia Server through the System Manager (3) functions of the software in each BioNetMedia Server. Users on the system are divided into levels of authorization with additional specific layers of authorization granted to specific users according to their job functions or clinical requirements. The primary division of users is the System User (8) and the Remote User (9). The System User (8) is the user that would typically be employed at the facility the owns the BioNetMedia Server (1) or is affiliated with the facility such as a physician like a radiologist that would use the BioNetMedia Server to provide radiology reports to patients over the Internet. The System User (8) also has a higher level system users which is the Administrator System User (7) that has the authority to create other user accounts (15) both system user accounts (8) and remote user accounts (9) and manage or administrate the BioNetMedia Server (1). The Remote User (9) is someone that is not employed or affiliated with the facility that owns the BioNetMedia Server (1) and is usually a patient that is remotely viewing their own medical files or a referring physician that has referred the patient to the facility to have a diagnostic procedure or some other procedure that would generate a report or digital patient data performed.

As shown in FIG. 1. when the patient goes to a hospital or other facility that has a BioNetMedia Server to have a procedure performed with a Diagnostic Scanner (11) or other data generating device, an Administrative System User (7) at the facility would enter the patient's demographic data into the create patient/user account (15) function of the BioNetMedia Server (1). In the BioNetMedia Server (1) the users including the patient users are managed in a data base and user verification system the User Manager (4) which provides a copy of the new user information such as name, gender, date of birth, email address, username and password and loss password and username verification information to the System Manager Server (2). The System Management Server (2) will then verify that the user is valid every time the user logs on to the system and allows the user to access their authorized folder/s and files in any BioNetMedia Server on the Internet. The User Manager (4) in the BioNetMedia Server (1) assigns each new user a username and password which is coordinated with the system management server (2) through the continuously active user verification system (21). The User Verification System allows the user to log into the system from any BioNetMedia Server's (1) log in screen. The records shown in Medical File Manager (5) and the files being streamed to the Virtual Remote Medical Diagnostic Imaging Viewer (6) to the user are coming from the server where the files and records are stored which is where the user will have had the remote user (9) account made.

A remote user (9) account can be a patient or a physician. The physician remote user (9) may only open and view files in Medical File Manager (5) that have them listed for access on the patient's electronic file folder. The patient has the ability to add or remove physician remote users to access the file folder in Medical File Manager but not system users or administrative system users which would not be shown on the authorized access list of the patient folder. If a patient remote user should move to a new city and go to a facility with a BioNetMedia Server for a procedure, they may enter new demographic data onto their patient folder which would edit the existing folder on the other BioNetMedia Server (1) over the Internet through the System Management Server (2) and its User Verification System (21) which would update the demographic meta data on the user and patient database in the System Management Server (2). When a patient remote user (9) log in, they are only able to access and view their own medical records (19) and files (20). The user interface of the system operates through an Internet browser such as Microsoft R Internet Explorer R or any other browser and computer that is compatible with java virtual machine software.

When a procedure is performed with a diagnostic scanner (11) or other data generating device or procedure, the records and data for the procedure is saved to a PACS or RIS or other record and data file storage system (10) to be accessed and viewed at the facility on a medical diagnostic workstation which is part of the device (12) or other workstation in the facility (13) that logs into the PACS or RIS (10). File may be saved to the BioNetMedia Server (1) directly from the PACS or RIS (10) such as existing files which are automatically saved as copies to the BioNetMedia Server through an HL7 interface and stored in Medical File Manager or can be accessed from where the files reside in the PACS or RIS (10) through an HL7 interface between the PACS or RIS (10) and the BioNetMedia Server (1) and then streamed to the user to be viewed remotely (20) inside the secure execution environment of the Virtual Remote Medical Diagnostic Viewer (6).

The user interface for this embodiment of the Invention features a medical file specific search engine that allows users to search for patient folders and files on all the BioNetMedia Servers on the Internet which contain files or records for that patient or patients that the non patient system user or remote user is authorized to access. The System creates a patient ID number that is confidential which can be used to create a blind data pool that is able to identify and filter data mining results for a single patient. The data is gathered from the metadata added to the patient's electronic folder and the metadata added to each patient file stored in Medical File Manager (5). The Invention is able to mine data from a blind data pool for the dissemination of trends in medical data by Public Health Agencies (27). The data would be de-identified and compiled into reports with images if required which would be streamed (25) to the public health agency.

FIG. 2 shows a flow chart representation of the method for creating electronic patient folders with identifying metadata for use with a search engine and creation of user accounts for system and data access. In a medical facility that has a BioNetMedia Server Installed, an employee that is a system user with the proper authorization levels set in the system would create a new patient folder (3) to be added to Medical File Manager (8) with a medical facility workstation (2) and populate the folder with files from a PACS or RIS using a Diagnostic Imaging Scanner Workstation Computer (1) or another Medical Facility Computer Workstation (2). When the new patient folder is being created (3) The system user adds the patient's identifying demographic information into the data fields of the electronic folder (4) also the system user enter the physicians that are authorized to access this patient folder and the BioNetMedia Server automatically creates new user accounts and notifies both the patient (6) and the physician (7) by email and provides access information for the patient or physician named in the list to log in to the BioNetMedia Server and view the files. When all the metadata is added to the folder the system user saves the completed folder to Medical File Manager (8) and then Medical File Manager automatically populates the folder with copies of files for that patient that it locates in other systems networked to the BioNetMedia Server (10). Medical File Manager then lets the patient and the physicians listed on the patient's folder to search for that patient's folder and files on that BioNetMedia Server and any BioNetMedia Server that contains any files for that patient (11). The patient or physician may access the files by logging into the BioNetMedia Server over the Internet (16) using a browser that links them through the website of the facility where the BioNetMedia Server is located (14). The patient may directly open their folder or the physician may search for the patient's files in Medical File Manager (13). The user views each files metadata (12) and makes a selection of which file to open (15) and then select view file to have the file streamed from the BioNetMedia Server to the virtual remote viewer in the user's computer (17).

FIG. 3 shows a representation of the method of accessing the system, searching for authorized data and remotely viewing and manipulating the data without the data being downloaded. The Patient (1) or the physician (2) accesses BioNetMedia over the Internet (14) and logs into the system (3) Where they enter the main menu of BioNetMedia and open Medical File Manager (5) which shows the patient only their own files and certain metadata attached to each file such as where the file is located or where it was made and what type of procedure is the file from, and when was the procedure done that made the file, and who was the referring physician for the procedure that made the file. The patient then selects a file to view from the list of files based on this metadata information displayed (7) and then clicks the view file button (8) for the BioNetMedia Server where the file is located to stream the file to the users remote viewer (9) The file is temporarily reconstructed in the viewer's secure execution environment (10) where the matrix transformation of the file allow for manipulation of the file inside the secure execution environment (11). The patient's viewer interface allows for manipulation of the images from the file without the file being downloaded (13). When the physician enters the main menu they may open Medical File Manager (6) and see all the patient folders they are authorized to access and all the files in those folders with all the metadata for the folders and the files. They may also search for files using the metadata terms as search terms in the BioNetMedia main menu search engine. The physician select the folders to open and the files to view based on the displayed metadata on the folder and files displayed in Medical File Manager and clicks view file (8) for the file to be streamed and reconstructed (10) and the physician may use the viewer to manipulate the files like annotating the images or highlighting pathology without having to actually download the image and then the physician has the added authorization on the system to save those annotations and highlighted pathology and the other function the viewer allows the physician to perform on the files to Medical File Manager (15). The annotations and edits to a file that is not downloaded is actually done by saving the annotation and edit information separately from the actual file that serves as a substrate for the annotations and edits that are recombined with the original file when the edited version of the file is selected to be viewed. This saves disk space by not creating new files and eliminates the requirement that the user have possession of the file in order to make a copy because the files are never actually downloaded.

FIG. 4 shows a representation of the layout and user interface of the user's main menu of the BioNetMedia Server and the user's access view of patient folders and their identifying demographic metadata as seen by a system user inside Medical File Manager of the BioNetMedia Server. The main menu display the name of the facility where the server is located and the name of the user that has logged in and the date and time at the top of the main menu screen. The user may use the main menu's search engine functions to locate a specific patient folder or patient's file by entering search criteria into the search engine's designated data fields which are the patient name (1) and or the type of procedure (2) the patient's date of birth (3) or the patient's gender (4) or the procedure date (11) and or the name of the referring physician (5). The user may filter their search by selecting to search all BioNetMedia Servers (8) or just the BioNetMedia Server that they are logged into (7) Users may switch out of Medical File Manager to search for files stored in “My Files” (6) the user's personal file storage system that does not allow access to these files to other users. The main menu has navigation buttons to move back or forward through the pages of the BioNetMedia system (11) and a screen refresh button (9) and the Go Button (10) which launches the browser after the user has entered the desired search criteria. When Medical File Manager opens in the main menu it shows the user the total number of patients folders the user is authorized to access (13). The folders are organized alphabetically with tabs represented in the interface allowing the user to manually select a desired letter of patient names by clicking the tab (22). Each section of folder has a display showing the number of folder under each letter that the user is authorized to access (21). The list of the folders and files has up and down arrows to navigate the list and a select button in the middle of the up and down arrows (23). Each patient's folder (24) is represented as a rectangle with identifying metadata such as the patient's name (18) the patient's identification number (16) their gender (19), the date of birth (20), a list of users authorized to access the folder (18), the number of files inside the folder (15) and an indicator of whether there are unseen files in the folder (14). When the user navigates through the list of folders, the folder is queued up to be selected is highlighted to differentiate that folder from the other folders the user may click the body of the folder itself (24) to open it or the select button (23).

FIG. 5 shows a representation of the BioNetMedia Server and the main menu with an access view of patient files waiting to be selected and viewed and their identifying demographic metadata as seen by a user inside Medical File Manager of a BioNetMedia Server. This view of Medical File Manager appears when the user has selected to open the folder. The alphabetical tab (1) would be set to the Letter of the patient's last name. Next to the navigation arrows would be a display of the number of files that the patient has in the folder (2). The files are shown as rectangles (12) with the metadata appearing on each one in the list. The metadata shows the location of the file or where the procedure was performed. Below that a display sow the status of the file (4) and below the status is a display showing the file name (5). In the center of the file is an icon that displays the file type graphically and has an animated flagged file icon. The patients name is displayed (7) and the date of the procedure or the date the file was made (11). There is a pull down list (9) that shows the primary physician and all the physicians authorized to access and view the file, it is the same list as the folder user list. To view the file the user clicks the “View File” button (10).

There are multiple advantages and benefits of the present inventive subject matter: (1) provide authorization to users as required for the function of the user; (2) provide automatic authorization and access for each patient to their records, files, and data; (3) provide the patient the ability to assign users the authorization to access their files, records, and data; (4) provide fast access to data, records, of files without providing access to other systems that are used to store records, data, and files of a medical provider; and (5) provide automatic access to physicians to records, data, files with authorization levels and access set for each patient by the patient and or the facility in which the embodiment of the invention is located or by remote access with proper authorization.

Electronically store a copy of records, files, and data originating from other systems and electronically store records, files, and data originating from the system itself or from records, files, and data originating from authorized remote users logged into the system or other systems that are embodiments of this system (the invention). Access to medical data to patients and physicians are much faster than present systems. Users are allowed to save copies of their files to a persistent memory device which are only viewable on the system when this patient has logged into their account. Users can access patient account data, which are perpetually active when they are created in this system, unless a patient is deceased.

A central similar embodiment of the invention with a whole system database retains the user information of any user and any patient that is made a user in the system or a patient in the system. The system provides email, voicemail, and specialized applications for visualization, data sharing, and document creation, data mining, and other applications remotely to authorized users.

The system helps a medical provider save money on operating costs by minimizing or eliminating the need to provide hard copies of data to patients and physicians or other authorized parties. The system allow the patient or their physician access to medical data without knowing where the data is actually located.

Thus, specific embodiments and applications of a file management access system have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system comprising:
a store of data including a data element;
a facility that streams the data element to a user; and
wherein the user has at least partial control over streaming of the data element to another.

2. The system of claim 1, wherein the data element comprises a media file.

3. The system of claim 1, wherein the data element comprises a medical image.

4. The system of claim 1, wherein the facility streams the data element to the user upon demand by the user.

5. The system of claim 1, further comprising an authorization subsystem wherein the user can designate different levels of access.

6. The system of claim 1, further comprising an authorization subsystem wherein the user can designate different levels of upload access.

7. The system of claim 1, further comprising an authorization subsystem wherein the user can designate access to specific individuals.

8. The system of claim 1, wherein the data store is distributed among a plurality of data servers.

9. The system of claim 8, wherein less an entirety of authorization codes is stored in any one of the plurality of data servers.

10. The system of claim 8, wherein each of the plurality of data servers pulls portions of the data store from a plurality of sources.

11. The system of claim 10, wherein at least one of the plurality of data servers pulls through an HL7 interface.

12. The system of claim 1, wherein metadata tagging of the data element is performed independently of the user.

13. The system of claim 12, wherein metadata tagging includes demographic information of the user.

14. The system of claim 12, wherein metadata tagging includes at least one of physician identification, diagnosis, treatment, and medical outcome information.

15. The system of claim 12, wherein the user can modify physician access to the data element.

16. The system of claim 1, wherein the data element comprises is a DICOM file

17. The system of claim 1, wherein the facility streams the data element to an applet.

18. The system of claim 1, wherein the facility streams the data elements to a virtual machine.
